(19) United States
(12) Patent Application Publication
(10) Pub. No.: US 2015/0220149 A1
(43) Pub. Date: Aug. 6, 2015

(54) SYSTEMS AND METHODS FOR A VIRTUAL GRASPING USER INTERFACE

(71) Applicant: Google Inc., Mountain View, CA (US)

(72) Inventors: Christian Plagemann, Menlo Park, CA (US); Hendrik Dahlkamp, San Francisco, CA (US); Varun Ganapathi, Palo Alto, CA (US)

(73) Assignee: Google Inc., Mountain View, CA (US)

(21) Appl. No.: 13/758,746

(22) Filed: Feb. 4, 2013

Related U.S. Application Data
(60) Provisional application No. 61/598,589, filed on Feb. 14, 2012.

(51) Int. Cl. G06F 3/01

(52) U.S. Cl. CPC G06F 3/017

(57) ABSTRACT

A location of a first portion of a hand and a location of a second portion of the hand are detected within a working volume, the first portion and the second portion being in a horizontal plane. A visual representation is positioned on a display based on the location of the first portion and the second portion. A selection input is initiated when a distance between the first portion and the second portion meets a predetermined threshold, to select an object presented on the display, the object being associated with the location of the visual representation. A movement of the first portion of the hand and the second portion of the hand also may be detected in the working volume while the distance between the first portion and the second portion remains below the predetermined threshold and, in response, the object on the display can be repositioned.

### RELATED APPLICATIONS

This application claims priority under 35 U.S.C. §119 to Provisional Patent Application Ser. No. 61/598,589, entitled “SYSTEMS AND METHODS FOR A VIRTUAL GRASPING USER INTERFACE” filed on Feb. 14, 2012. The subject matter of this earlier filed application is hereby incorporated by reference.

### TECHNICAL FIELD

This description relates to user interface systems and methods associated with a computing device and, more specifically, to an interface based on virtual grasping gestures for interacting with a computing device.

### BACKGROUND

Computing devices can have several mechanisms through which a user may interact with (e.g., trigger) one or more functions of the computing device. For example, dedicated user interface devices such as keyboards, mouse devices, touch screen displays, etc., may allow a user to interact with a computing device to perform one or more computing functions. Such user interface devices can be connected with and/or integrated into the computing device. Such user interface devices often require a user of the computing device to work within multiple working regions associated with the computing device. For example, a mouse may be located on a surface adjacent a computing device and a keyboard may be located on the computing device itself. Thus, the user must move his or her hand(s) between two different working regions while changing between a keyboard function (e.g., typing) and a cursor function (e.g., mousing). Such user interface devices may be cumbersome to use and/or may not produce results at a desirable speed and/or level of accuracy. Furthermore, some computing devices may be used in an environment (e.g., an automobile dashboard, heads-up display, or wall-mounted display) that makes using traditional interfaces devices, such as a mouse and a keyboard, impractical.

### SUMMARY

In one general aspect, a computer program product can be tangibly embodied on a computer-readable storage medium and include instructions that, when executed, cause the computing device to perform a process. The instructions can include instructions that cause the computing device to detect a plurality of parts of a human hand within a working volume of a computing device. Based on detection, the instructions can cause the computing device to determine that the plurality of parts is in a configuration suitable for a grasping gesture. The instructions may further cause the computing device to translate a location of the plurality of parts to a visual representation on a display of the computing device, the visual representation allowing the user to interact with the computing device.

In another general aspect, a computer-implemented method can include detecting, at a computing device, a location of a first portion of a hand and a location of a second portion of the hand within a working volume of a computing device. The method can also include identifying a focus point located between the first location and the second location and positioning a cursor on a display of the computing device based on the focus point.

In another general aspect, a computer-implemented method can include detecting, by one or more processors, a first location of a first portion of a hand and a location of a second portion of the hand within a working volume of a computing device. The method can also include determining that the first portion of the hand and the second portion of the hand are in a horizontal plane and position a visual representation on the display of the device based on the first location and the second location, wherein the hand is not in contact with the display of the computing device.

In another general aspect, a system can include instructions recorded on a non-transitory computer-readable medium and executable by at least one processor and a gesture classification module configured to detect a gesture of a user within a working volume associated with a computing device, the gesture classification module configured to trigger initiation of a gesture cursor control mode of operating the computing device when the gesture matches a predetermined gesture signature stored within the computing device. The system can also include an imaging device configured to provide imaging data associated with the working volume to the gesture classification module. The system can also include a gesture tracking module configured to position a cursor within a display portion of the computing device at a location based on a position of a first portion of the hand and a position of the second portion of the hand within the working volume and to move the cursor within the display portion to correspond to movement of the first portion of the hand and the second portion of the hand within the working volume when the computing device is in the gesture cursor control mode.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic illustration of a computing device according to an implementation.

FIG. 2 is an illustration of a computing device, according to an implementation.

FIG. 3 is an illustration of the computing device of FIG. 2, showing a working volume associated with the computing device according to an implementation.

FIG. 4 is an illustration of the computing device of FIG. 2, showing a text-based control mode of operation, according to an implementation.

FIG. 5 is an illustration of the computing device of FIG. 2, showing a gesture cursor control mode input by a user, according to an implementation.

FIG. 6 is an illustration of the computing device of FIG. 2 showing a gesture cursor control mode of operation, according to an implementation.

FIG. 7 is an illustration of the computing device of FIG. 2, showing a select function, according to an implementation.

FIG. 8 is an illustration of the computing device of FIG. 2, showing a select and drag function, according to an implementation.

FIG. 9 is a flowchart that illustrates a method of providing a virtual grasping user interface, according to an implementation.

### DETAILED DESCRIPTION

A virtual grasping user interface system as described herein can employ a virtual input space including hand/finger gesturing in a working volume, such as the area in front of a capture device, to enable efficient and ergonomic text entry and/or selection/manipulation of user interface elements of the computing device. Using a capture device, such as a 3D camera, and recognition software, the selection and manipulation of user interface elements can be triggered using gestures by a user without using a physical input device, such as a mouse, a touchpad, a touch screen, etc. A surface, such as a keyboard, and a working volume above the surface can be used for both text entry and selection and manipulation of user interface elements such that minimal hand motion is needed by a user. In other words, the user can work within a single unified working space to switch between one mode of user interaction (e.g., text entry) to another mode of user interaction (e.g., mousing or cursor control).

As described herein, modes of operation of a computing device can be triggered and operated by a grasping user interface system and methods. For example, a system and methods for changing between a text based (e.g., keyboard) control mode of operation and a gesture cursor control mode of operation of a computing device is described herein. The text based control mode of operation allows a user of the computing device to perform text entry or typing functions using, for example, a keyboard portion of the computing device. The gesture cursor control mode of operation of the computing device allows a user to maneuver and position a cursor within a display portion of the computing device by moving two portions of the user's hand (e.g., a thumb and a finger tip) within a working space. A working space may include a region in-range of a capture device, such as a region above the surface of the keyboard portion of the computing device, or a region next to the computing device. Thus, the user can control the cursor without the need for physical contact with a separate input device, such as a mouse, touchpad, trackpad or touch screen.

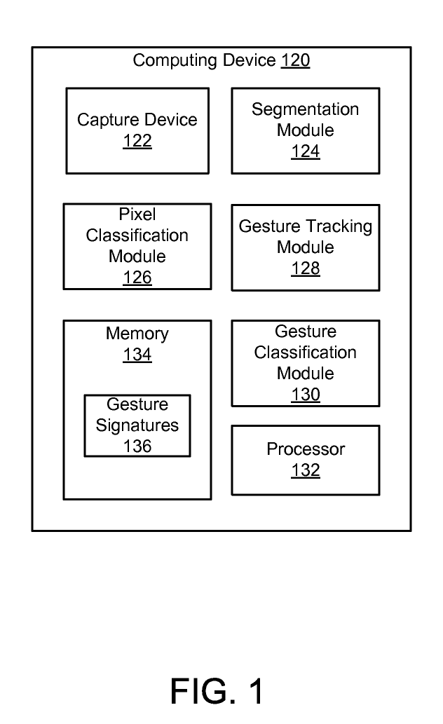

FIG. 1 is a schematic illustration of a computing device 120 on which the systems and methods described herein can be embodied. The computing device 120 can be, for example, a computing entity (e.g., a personal computing device, such as, a laptop computer, a desktop computer, a netbook computer, a tablet, a touchpad, etc.), a server device (e.g., a web server), a mobile phone, a personal digital assistant (PDA), an e-reader, etc. The computing device 120 can be, for example, a wired device and/or a wireless device (e.g., Wi-Fi enabled device). The computing device 120 can be configured to operate based on one or more platforms (e.g., one or more similar or different platforms) that can include one or more types of hardware, software, firmware, operating systems, runtime libraries, etc.

As shown in FIG. 1, the computing device 120 can include a virtual grasping interface system that can include a capture device 122, a segmentation module 124, a pixel classification module 126, a gesture tracking module 128, and a gesture classification module 130. The computing device 120 can also include one or more processors 132, and a memory 134 that can store thereon one or more gesture signatures 136. The computing device 120 can also include, a display portion (not shown in FIG. 1) and a keyboard portion (not shown in FIG. 1).

In some implementations, the computing device 120 can represent a cluster of devices. In such an implementation, the functionality and processing of the computing device 120 (e.g., one or more processors 132 of the computing device 120) can be distributed to several computing devices of the cluster of computing devices.

In some implementations, one or more portions of the components shown in the computing device 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the gesture tracking module 128 can be, or can include, a software module configured for execution by at least one processor (not shown). In some implementations, the functionality of the components can be included in different modules and/or components than those shown in FIG. 1. For example, although not shown, the functionality of the gesture classification module 130 can be included in a different module, or divided into several different modules.

The components of the computing device 120 can be configured to operate within an environment that includes an operating system. In some implementations, the operating system can be configured to facilitate, for example, classification of gestures by the gesture classification module 130.

In some implementations, the computing device 120 can be included in a network. In some implementations, the network can include multiple computing devices (such as computing device 120) and/or multiple server devices (not shown). Also, although not shown in FIG. 1, the computing device 120 can be configured to function within various types of network environments. For example, the network can be, or can include, a local area network (LAN), a wide area network (WAN), etc. implemented using, for example, gateway devices, bridges, switches, and/or so forth. The network can include one or more segments and/or can be have portions based on various protocols such as Internet Protocol (IP) and/or a proprietary protocol. The network can include at least a portion of the Internet.

The memory 134 of the computing device 120 can be any type of memory device such as a random-access memory (RAM) component or a disk drive memory. The memory 134 can be a local memory included in the computing device 120. Although not shown, in some implementations, the memory 134 can be implemented as more than one memory component (e.g., more than one RAM component or disk drive memory) within the computing device 120. In some implementations, the memory 134 can be, or can include, a non-local memory (e.g., a memory not physically included within the computing device 120) within a network (not shown). For example, the memory 134 can be, or can include, a memory shared by multiple computing devices (not shown) within a network. In some implementations, the memory 134 can be associated with a server device (not shown) on a client side of a network and configured to serve several computing devices on the client side of the network.

The display portion of the computing device 120 can be, for example, a liquid crystal display (LCD), a liquid emitting diode (LED) display, television screen, or other type of display device. In some implementations, the display portion can be projected on a wall or other surface or projected directly into an eye of the user. The optional keyboard portion of the computing device 120 can include, for example, a physical keyboard (e.g., includes physical keys that can be actuated by a user), a virtual keyboard (e.g., a touchscreen or sensing area), an optically projected keyboard (e.g., a projected display of a keyboard on a surface), or an optical detection keyboard (e.g., optically detects hand and/or finger motion of a user). In some implementations, the keyboard portion can also include various input devices, such as for example a touchpad or trackpad. In some implementations, the keyboard portion can be a device that can be electrically coupled to the computing device 120 (e.g., wired device). In some implementations, the keyboard portion can be integral with the computing device 120 (e.g., such as with a laptop). In some implementations, the keyboard portion can be Wi-Fi enabled to communicate wirelessly with the computing device 120. In further implementations, the computing device 120 can perform its functions without a keyboard portion using solely the grasping interface described in this document and/or other means of user interaction.

As used herein, a working volume may be the space or region that is in-range of the capture device 122. In some embodiments, the working volume may include the space or region above a surface associated with or near the computing device. The working volume can be, for example, a working space or region in which users of the computing device 120 places their hands during operation of the computing device 120, such as above a keyboard portion of the computing device. In other embodiments, the working volume may be an area above a table surface proximate the computing device, or an area in front of a display device, or any other defined area accessible to the capture device 122.

The capture device 122 can be, for example, a device configured to provide 3-dimensional (3D) information associated with the working volume. For example, the capture device 122 can be, a camera, such as, for example, a 3D camera, a depth camera, or a stereo camera (e.g., two or more cameras). In some implementations, the capture device 122 can be, for example, an above-the-surface sensing device (e.g., using infrared (IR) or ultrasound sensors embedded in the keyboard), or a time-of-flight camera (e.g., a range imaging camera system that the known speed of light and measures the time-of-flight of a light signal between the camera and the subject being imaged). In some implementations, the capture device 122 can be a monocular vision camera, in which case advanced computer vision algorithms are used to interpret the spatial structure of the scene. The capture device 122 can be a separate component that can be coupled to the computing device 120 or can be integrated or embedded within the computing device 120. For example, the capture device 122 can be embedded into a bezel portion of the computing device 120, such as along a top edge above the display portion of the computing device 120. In some implementations, the capture device 122 can be disposed below the display portion of the computing device 120. For example, the capture device 122 can be embedded within a lower bezel portion of the computing device 120.

The capture device 122 can be used to capture or collect 3D information (e.g., range-imaging data) associated the defined working volume, such as the area above a surface of the keyboard portion of the computing device. The 3D information can be used to, for example, identify movement of portions of a hand (e.g., thumb and and/or fingers) of the user, for example, gesture inputs or interactions by the user as described in more detail below. The 3D information can be used by the gesture tracking module 128 and the gesture classification module 130 to identify a gesture input or interaction by a user of the computing device 120. In some embodiments the information may be used to determine if the gesture input matches a gesture signature 136 stored within the memory 134. For example, one or more gesture signatures 136 can be predefined and stored within the memory 134 of the computing device 120.

In some implementations, a gesture signature 136 can be defined to trigger a change of an operational mode of the computing device 120 from a text based control mode of operation to a gesture cursor control mode of operation (or vice-versa) of the computing device 120. For example, in some implementations, a gesture signature 136 can include a prerecorded and stored gesture signature 136 that includes a specific alignment of portions of the user's hand, such as the tip of a user's thumb and the tip of the user's finger. When a user performs a gesture interaction that matches the stored gesture signature 136, the system can change the mode of operation of the computing device 120 from the text based control mode of operation to the gesture cursor control mode of operation of the computing device 120. When the computing device 120 detects that the portions of the user's hand are no longer aligned, the system can change the mode of operation from the gesture cursor control mode of operation to the text based control mode.

In some implementations, a gesture input or interaction (also referred to herein as a “gesture”) by a user can be any type of non-electrical communication with the computing device 120. In some implementations, the gesture can include any type of non-verbal communication of the user such as a hand motion or hand signal of a user that can be detected by, for example, the capture device 122 of the computing device 120. In some implementations, detection of a gesture can be referred to as registration of the gesture, or registering of the gesture.

A gesture signature 136 can be, for example, a prerecorded and stored visual hand or finger motion of the user that can be used to trigger a function within the computing device 120. A gesture signature 136 can include a prerecorded and stored path or trajectory of the motion of a user's hand or certain portions of a user's hand. A gesture signature 136 can be, for example, a special hand gesture to trigger a change of mode of operation (as discussed above), such as a certain alignment of the user's thumb and finger, clapping or waving of the user's hands, selection of a certain key, etc., a movement gesture (e.g., moving the aligned portions of the hand in the working space), a selection gesture (e.g., the user brings a finger and thumb together), a drag gesture (e.g., the user moves his or her hand in the working space holding the thumb and finger together), etc. It should be understood that these are just example gestures and gesture signatures, as other gestures and gesture signatures can also be included.

When the computing device 120 is in the gesture cursor control mode of operation, the 3D information provided by the capture device 122 can be used to identify a location within the working space of certain portions of a user's hand (e.g., a finger tip, a tip of the thumb, the thenar webbing, etc.) and allow the user to maneuver and position a cursor within the display portion of the computing device 120 based on the located portions of the user's hand. In other words, rather than using a physical input device, such as, for example, a mouse or a trackpad or touchpad, to move the cursor, the user can position and move portions of his or her hand within the working volume to maneuver the cursor. When the text based control mode of operation is activated, the user can enter text (e.g., type) using, for example, the keyboard portion of the computing device 120. In some implementations, the computing device 120 may also include a physical input device such as a mouse or trackpad or touch pad, and can use the physical input device to maneuver the cursor while in the text based control mode of operation if desired. A particular gesture signature (e.g., an alignment of portions of the user's hand) may allow the computing device 120 to differentiate between a gesture control operation and when the user is just moving his or her hand to pick up, for example, a cup of coffee or a pencil.

In some implementations, the mode of operation of the computing device 120 can be determined based only on the position of portions of the user's hand. In other embodiments, the mode of operation may be changed by pressing or touching a selected portion (e.g., a selected key) of the keyboard portion of the computing device 120. In some implementations, the same event (e.g., a gesture or actuating a special key) can be used to switch between the gesture cursor control mode of operation and the text based control mode of operation. In some implementations, the mode of operation can be changed when a time out occurs. For example, if the computing device 120 is in the gesture cursor control mode, the mode can be changed automatically to the text based control mode of operation after a predetermined time period. In some implementations, the text based control mode of operation can automatically be triggered when, for example, a text field within the display portion of the computing device 120 is selected while in the gesture cursor control mode. In some implementations, the gesture cursor control mode of operation can be automatically triggered when the cursor is moved out of a text field within the display portion of the computing device 120. For example, after the user has entered desired text into a text field and moves out of that text field, the gesture cursor control mode can be automatically triggered.

When the computing device 120 is in the gesture cursor control mode of operation, the gesture tracking module 128 can track the movement of selected portions of the user's hand (e.g., tip of thumb, finger tip, thenar webbing) within the working volume of the computing device 120 and, based on the location of the selected portions of the user's hand, provide selection with and manipulation of a cursor within the display portion of the computing device 120. For example, the gesture tracking module 128 can localize the position of the portions of the user's hand (e.g., tip of thumb and finger tip) within the 3D working volume and estimate a distance between the two portions when the two portions are in a certain alignment. For example, the gesture tracking module 128 may determine that the two portions of the user's hand are in a configuration suitable for a grasping gesture, such as generally aligned in a horizontal plane, within the working volume. For example, the index finger and thumb may be aligned horizontally with respect to a reference surface, such as a table top or keyboard. In some embodiments, the gesture tracking module 128 may locate a third portion of the user's hand, such as the thenar webbing, and determine whether the three portions are in a configuration suitable for a grasping gesture (e.g., generally in a horizontal plane in the working volume). For example, the system may determine that the index finger, the thumb, and the thenar webbing are aligned horizontally with respect to the reference surface. The thenar webbing is the portion of the hand at the base of the thumb and the index finger. When the three portions of the user's hand are in a configuration suitable for a grasping gesture (e.g., generally horizontally aligned), the gesture tracking module 128 may determine that the user has initiated a gesture tracking mode.

In the gesture tracking mode, the gesture tracking module 128 can track and monitor the location of one portion of the user's hand (e.g., the tip of the thumb) relative to another portion of the user's hand (e.g., the fingertip) and estimate a location between the two portions. For example, the gesture tracking module 128 may estimate a location between the thumb and finger that is ⅓ of the distance from the thumb to the finger, so that the location is closer to the thumb than to the finger. In other embodiments, the gesture tracking module 128 may estimate a location that is half way between the thumb and the finger. The location between the two portions of the user's hand may be referred to as a focal point. Once the gesture tracking module 128 has determined the focal point, the gesture tracking module 128 can map the location of the focal point in the working volume to a location on the display portion of the computing device 120. In some embodiments, the mapping provides absolute cursor positioning, rather than relative cursor positioning that is typically provided by a mouse or touchpad. In other words, there is a fixed, constant mapping between the working volume (e.g., a defined region or space associated with a computing device) and the display portion of the computing device, which allows the user to immediately position the cursor at the intended position, rather than having to consider the current position of the mouse cursor and navigating it in a relative manner to the desired position within the display portion of the computing device 120. In alternative implementations, the gesture cursor control mode can be implemented using such known relative positioning of the cursor motion.

The mapping between the user's 3D working volume and the 2D display region of the graphical interface may take different forms. In one implementation, the mapping takes the form of a 90 degree rotation around the axis of the display bezel followed by a projection, such that a forward-backward motion of the user's hand is mapped to an up-down motion on the display. In other implementations the mapping is not rotated and the up and down motion of the user's hand moves the cursor up-and-down on the display. In such embodiments a backward motion of the user's hand may cause a zoom in and a forward motion may cause a zoom out. In another implementation, the mapping takes a curved (or warped) form to better match the anatomy of the human hand. In such an implementation, for example, a curved motion of the finger tip during a grasping motion (e.g., bringing the finger and thumb together) would be warped, so that the cursor does not move during the grasp but rather remains stationary on top of the currently selected interface element. In yet another implementation, the mapping is translated and scaled, such that a smaller region of the working volume is mapped to the display or a larger region, or a region translated to the side. In further implementations, the scaling and translation parameters of the mapping adapt to the user's behavior during use.

The gesture cursor control mode of operation may also allow the user to perform select (e.g., click) and drag functions by performing a grasping motion and moving the user's hand in the working space of the computing device 120. For example, the user can close the space between two portions of the user's hand (e.g., by closing the thumb and finger tip) to trigger a grasping event. For example, if the user wants to select an element on the display portion of the computing device, the user can, for example, position a cursor over the desired location (e.g., the hand hovering within the working volume with the thumb and finger open), and then move the finger tip to the thumb to trigger a select function. The user can move the hand with the finger tip and thumb closed in the working volume to perform a continuous dragging action. For example, the user can drag or move the selected element within the display portion of the computing device 120. In some embodiments, the select function (i.e., the grasping event) ends when the user releases the touch of the finger tip to the thumb. In further embodiments a user may select (e.g., “click”) on an item by performing a quick grasp (i.e., quickly closing and opening the thumb and finger).

To terminate the gesture cursor control mode of operation of the computing device 120 and trigger the text based control mode of operation, the user can simply move the hands into a position where the portions of the hands are no longer in the specified alignment. For example, when the user places his or her hands on the keyboard, tip of the thumb, the fingertip, and the thenar webbing are no longer generally in a horizontal plane. This may trigger the end of the gesture cursor control mode. In other implementations, the user may perform a special gesture, such as a clapping gesture, use a special key of the keyboard portion, or use a vocal command to trigger the change. When in the text based control mode of operation, the user can key in text, use a mouse or touchpad or trackpad (if included on the computing device), and otherwise use the various functions provided on a text entry device (i.e., a keyboard portion) of the computing device 120 in a typical manner.

In some implementations, in operation, the capture device 122 can bring in raw data (e.g., imaging data) associated with the working volume and provide the raw data to the segmentation module 124. The segmentation module 124 can distinguish between the foreground and background of the raw imaging data and remove static parts of the imaging data, leaving only the dynamic parts of the imaging data. For example, the segmentation module 124 can identify the motion of the hand of the user within the working volume. The segmentation module 124 can then provide the segmented data to the pixel classification module 126. The pixel classification module can use the information provided by the segmentation module 124 to identify and classify various parts of the 3D information (e.g., imaging data). For example, the pixel classification module 126 can assign a class to individual pixels within the imaging data, such as for example, pixels associated with a hand, a finger, a finger tip, a tip of the thumb, the thenar webbing, etc. The classification results provided by the pixel classification module 126 can be provided to the gesture tracking module 128. The segmentation module 124 and the pixel classification module 126 can each include any hardware and/or software configured to facilitate the processing of the 3D information provided by the capture device 122.

The gesture tracking module 128 can accumulate the classification results (from the pixel classification module 126) over time and construct a path or trajectory of the movement of preselected portions of the user's hand (e.g., finger tip, tip of thumb) within the working volume. For example, the capture device 122 can collect 3D information associated with the working volume at a rate of 30, 40, 50, 60, etc. times per second, and that information can be provided to the gesture tracking module 128 for each frame. The gesture tracking module 128 can accumulate the 3D information (e.g., imaging data) to construct a path or trajectory of the movement of the preselected portions of the user's hand and associate with the path various features related to the position and movement of the portion of the user's hand, such as distance between two portions of the hand (e.g., thumb and finger tips), velocity, acceleration, etc. For example, the gesture tracking module 128 may use velocity and acceleration to determine the difference between a click-and-drag gesture and a click-and-flick gesture (e.g., a fast grasp-swipe-open gesture) that is interpreted as a delete, or throw away, operation. The gesture tracking module 128 can include any hardware and/or software configured to facilitate processing of the motion of the portion of the user's hand.

The constructed path(s) and associated features can be analyzed by the gesture classification module 130 to determine an associated gesture signature that matches the path of motion of the selected portion of the user's hand. For example, the path can be associated with a gesture input or interaction by the user as described above, and that gesture interaction can be compared to stored gesture signatures 136 within the memory 134 of the computing device 120.

The gesture classification module 130 can be configured to process (e.g., detect, analyze) one or more gesture interactions by a user with the computing device 120. The gesture classification module 130 can be configured to, for example, detect a gesture (i.e., a gesture interaction), define a representation of the gesture and/or trigger initiation of a gesture cursor control mode of the computing device 120 in response to the gesture. The gesture classification module 130 can include any hardware and/or software configured to facilitate processing of one or more gesture interactions associated with the computing device 120.

As discussed above, the capture device 122 can collect 3D information associated with the working volume, for example, at a rate of 30, 40, 50, 60, etc. times per second, and the above described loop through the various modules can be processed for each frame (e.g., each image). In some implementations, the hardware and/or software of the gesture classification module 130 can be configured to actively monitor for a gesture interaction (e.g., actively scan or sample), or can be configured to passively detect a gesture interaction. For example, the capture device 122 can be configured to periodically capture/generate/process images to continuously monitor for an interaction (e.g., a hand signal) with respect to the computing device 120 that could be a gesture interaction.

In some implementations, the computing device 120 can include a special classifier module (not shown) that is separate from the gesture classification module 130 and that can be used to trigger the gesture cursor control mode of operation. For example, a special classifier module can receive imaging data from the capture device 122 and identify and compare a gesture provided by a user to a stored gesture signature. In such an implementation, the special classifier module compares the imaging information directly with stored gesture signature images.

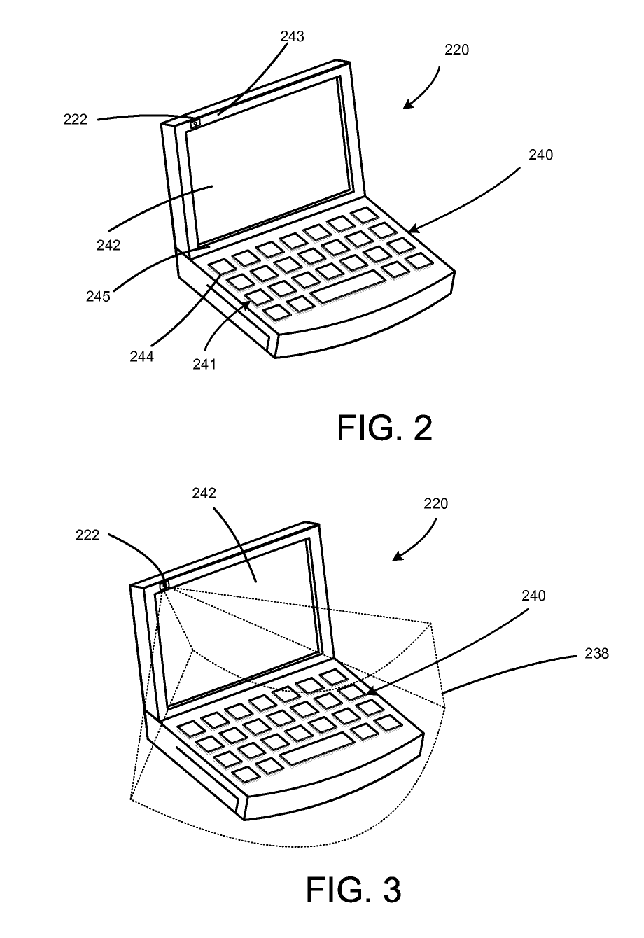

FIGS. 2-8 illustrate an example implementation and use of a computing device 220 that includes a virtual grasping user interface system as described above. As shown in FIG. 2, in this implementation, the computing device 220 is a laptop computer and includes a keyboard portion 240 and display portion 242. The keyboard portion 240 can include a plurality of keys 241 used on typical computing devices (e.g., a QWERTY keyboard layout). In this implementation, the plurality of keys 241 include a special actuation key 244 that can be used to trigger a change of a mode of operation of the computing deice 220 as described in more detail below.

The computing device 220 also includes a user input system (also referred to herein as “system”) that includes a capture device 222 embedded within a top bezel portion 243 of the computing device 220. The capture device 222 can be, for example, a 3D camera or other device configured to provide 3D information as described above for computing device 120. The capture device 222 is shown embedded in a top left corner of the bezel portion 243, but as discussed above, the capture device 222 can alternatively be disposed at a different location along the top bezel portion 243 or along a bottom bezel portion 245 of the computing device 220.

Although not shown in FIGS. 2-8, the system can also include a segmentation module, a pixel classification module, a gesture tracking module, a gesture classification module, a memory, one or more gesture signatures stored within the memory and a processor as described above for computing device 120. These components can be the same as or similar to, and function the same as or similar to, the components of the same name described above for computing device 120.

As shown in FIG. 3, a working volume 238 can be defined, for example, above the keyboard portion 240. As described above, the working volume 238 can be defined as a space or region in the range of capture device 222, in which users of the computing device 220 can place their hands during operation of the computing device 120. It should be understood that the working volume 238 is an example working volume as other working volumes, such as a space above a desk or table surface near the computing device or an area in front of a display, can be defined depending on factors, such as, for example, the range and scope of the capture device and the size and type of computing device, the size and type of keyboard portion and/or display portion, etc. As described above for computing device 120, the capture device 222 can be configured to provide 3-dimensional (3D) information associated with the working volume 238.

The 3D information collected by the capture device 222 can be used to, for example, identify hand and/or finger motions of a user, for example, gesture inputs or interactions by the user as described above for capture device 122. The 3D information can be used by the gesture tracking module and the gesture classification module to identify a gesture input or interaction by a user of the computing device 220, and determine if the gesture input matches a gesture signature predefined and stored within the memory of the computing device 220.

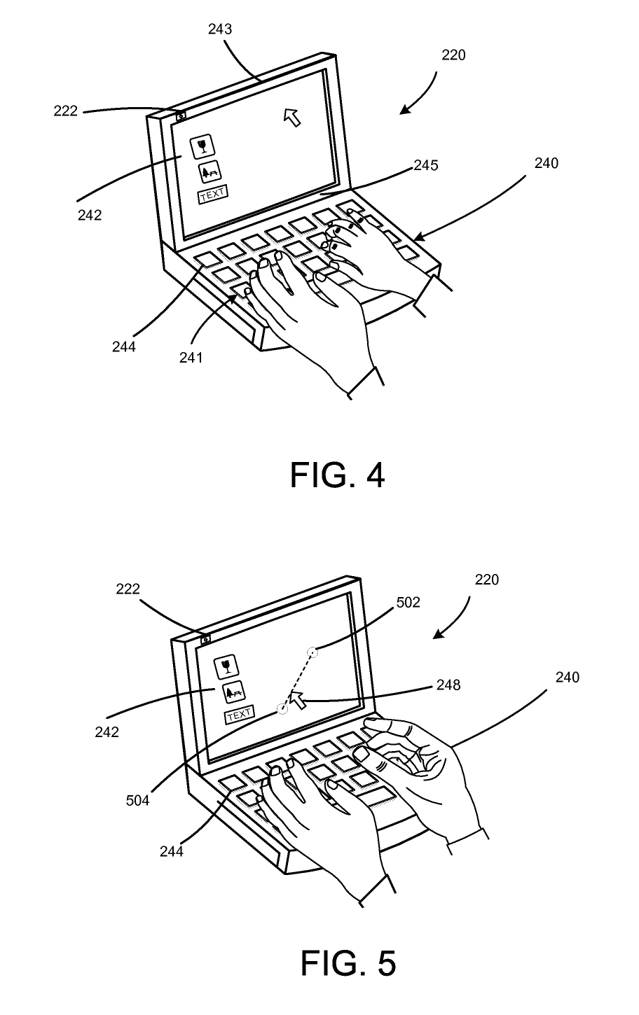

The computing device 220 can provide the user with two modes of interaction while the user's hands remain within the working volume 238. Specifically, as discussed above for computing device 120, the computing device 220 can toggle between a text based control mode of operation and a gesture cursor control mode of operation. FIG. 4 illustrates a user (e.g., the user's hands) using the computing device 220 in the text based control mode of operation. In this mode of operation, the user can use the plurality of keys 241, for example, to type or key-in desired text and perform functions typically done with known computing devices. While in the text based control mode of operation, the system can ignore any detected hand and/or finger motion of the user.

In the implementation depicted in FIGS. 4-8, when the user desires to perform a cursor function, the user can perform or provide a gesture interaction or input to trigger the computing device 220 to change to the gesture cursor control mode of operation. For example, as shown in FIG. 5, the gesture configured to trigger the gesture cursor control mode of operation may include the user holding one hand in a grasping gesture, with the palm facing inward within the working volume 238, as shown in FIG. 5. In such a hand gesture the tip of the user's thumb and index finger and the thenar webbing are all located in plane that is generally horizontal to the keyboard. Although not shown in FIG. 5, the user's other hand may remain on the keyboard.

When the user performs this gesture input or interaction, the gesture classification module can compare the gesture interaction of the user to stored gesture signatures within the memory of the computing device 220. If the gesture interaction of the user matches the stored gesture signature assigned to trigger the gesture cursor control mode of operation, the gesture cursor control mode of operation will be initiated and the text based mode of operation will be terminated. A gesture tracking module may determine a location of two portions of the user's hand, such as the finger tip and the tip of the thumb in the working volume. In some embodiments, the gesture tracking module 128 translates the location of the portions into a location on the display. For example, the location of the tip of the finger may translate to location 502 shown in FIG. 5 and the location of the tip of the thumb may translate to location 504 shown in FIG. 5. The gesture tracking module 128 may determine a location between location 502 and location 504 and position the cursor 248 between the two locations. In some embodiments, the cursor 248 is positioned closer to the location of the thumb 504 than the location of the finger 502. In other embodiments, the cursor is positioned half way between locations 502 and 504. Locations 504 and 502 are shown as hashed lines because they may not actually appear on display 242. In other embodiments, the gesture tracking module 128 may determine the focus point (i.e., the location between the location of the thumb and finger) and translate just the focus point to a location on the display 242.

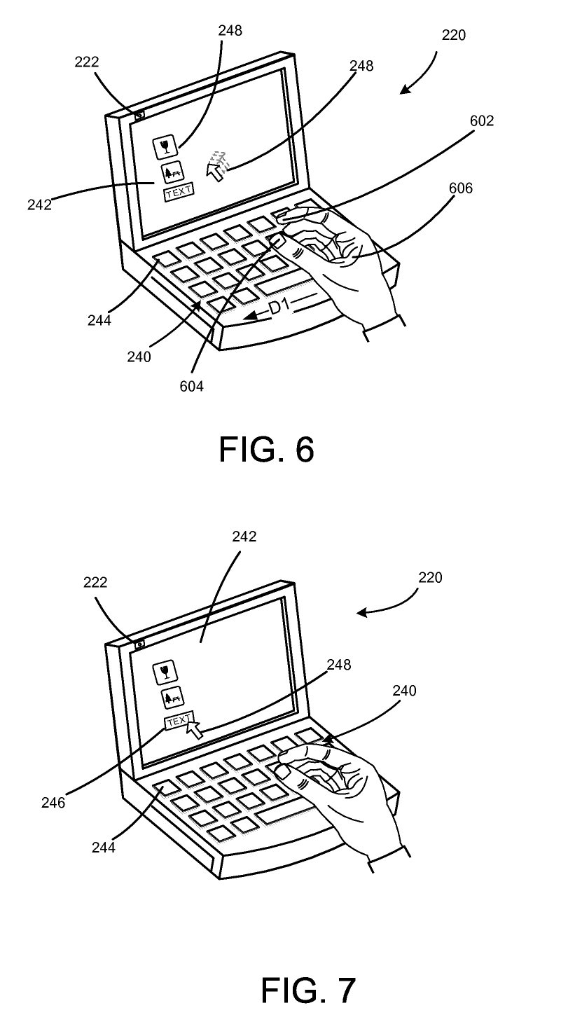

As discussed above, when the computing device 220 is in the gesture cursor control mode of operation the user can manipulate and position a cursor 248, shown in FIG. 6, within the display portion 242 by moving portions of the user's hand within the working volume 238. In this example implementation, the portions of the hand include the tip of the thumb and the tip of the index finger moving in the direction of D1, as shown in FIG. 6. As described above for computing device 120, the virtual grasping input system can identify and track the location of the finger tip 602, the thumb 604, and the thenar webbing 606 within the working volume 238, determine a location between the finger tip 602 and the thumb 604, map the location to the display portion 242 to provide absolute positioning of the cursor 248 within the display portion 242. The user can use the thumb and finger tip to move the cursor 248 within the display portion 242 in the same or similar manner as a mouse, touchpad or trackpad, while maintaining the hands of the user within the working volume 238, and without making contact with the display portion 242.

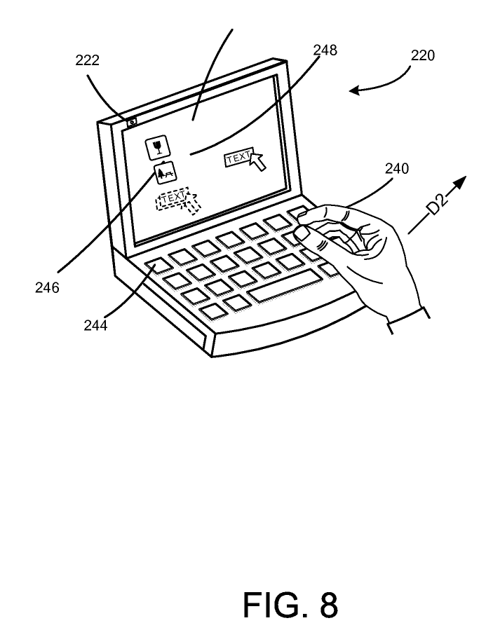

The user can also perform various functions, such as for example, select, drag and drop functions while in the gesture cursor control mode. For example, the user can complete a grasp by, for example, closing the distance between the thumb and the finger (as shown in FIG. 7) so that the distance falls below a predetermined threshold. The system may detect and identify this event as a grasping event. For example, to select an element 246 within the display portion 242, the user can position the thumb and finger in such a manner to position or place the cursor 248 on the element 246, and then can select the element 246 by closing the finger tip and thumb tip, as shown in FIG. 7. The user can also drag the element 246 by moving the closed grasp in direction D2, as shown in FIG. 8. The user can release or drop the element 246 by releasing the grasp, i.e., opening the finger and the thumb. In some embodiments, the user may delete an item with a grasping event followed by a flick (i.e., a high acceleration drag followed by a release of the grasping event). In other embodiments, the user may make an item larger (e.g., zoom in) with a grasping event followed by a backward motion (i.e., the user drawing his or her hand closer to the body). Those of ordinary skill will realize that the grasp event may occur using a scroll bar control and the user may scroll through a document using the grasp-and-drag events.

When the user desires to switch back to the text based control mode of operation, in this implementation, the user can simply put the hand back atop the keyboard portion 240, as shown in FIG. 4 Such a hand gesture breaks the alignment of the portions of the hand that were in a generally horizontal plane. In other embodiments the user can tap or press the special actuation key 244 (shown in FIG. 2) to switch to the text based control mode. Either of these actions may terminate the gesture cursor control mode of operation and trigger the text based control mode of operation, allowing the user to switch between the text based control mode of operation and the gesture control mode of operation as desired.

In alternative implementations, rather than simply placing the hands in a typing position or using a special actuation key (e.g., 244) to trigger the change to the text based control mode of operation, a user may use other gesture interactions, such as waving the hands, clapping the hands, or snapping the fingers. The gesture interaction can be the same as or different than the gesture designated to trigger the gesture cursor control mode of operation. In some alternative implementations, the computing device 220 can use one or more special actuation key(s) to trigger both the text based control mode of operation and the gesture cursor control mode of operation.

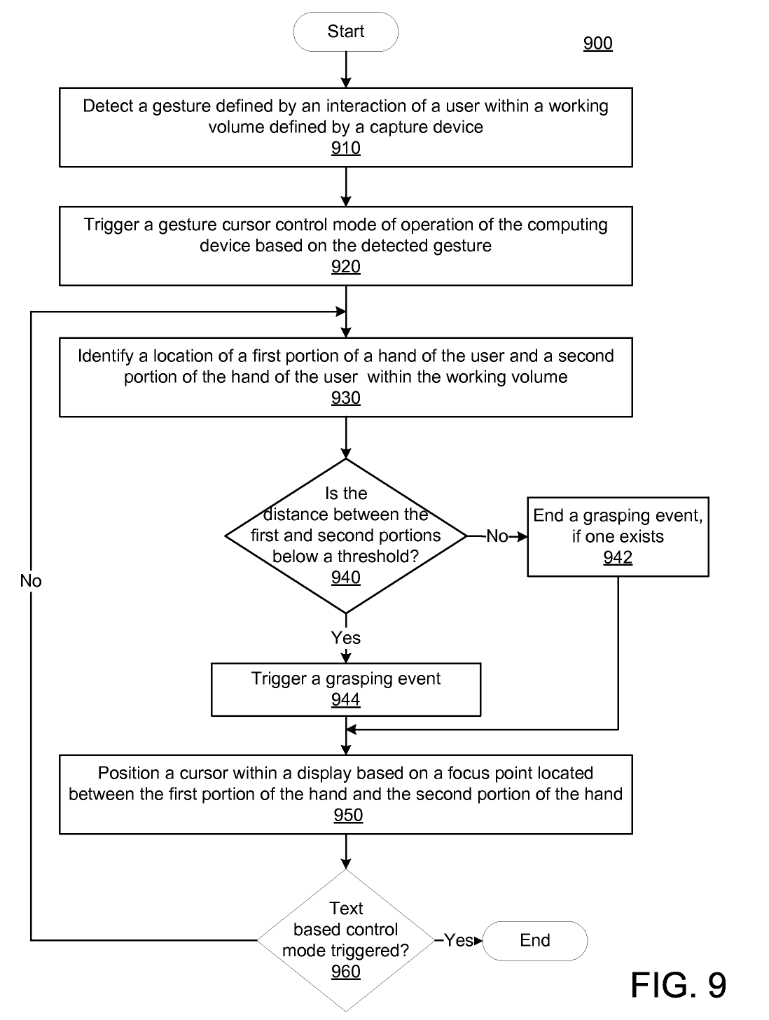

FIG. 9 is a flowchart illustrating a method of providing a grasping user interface, consistent with disclosed embodiments. The method may be performed by a computing device, such as devices 120 and 220. The method includes detecting a gesture defined by an interaction of a user within a working volume (e.g., 238) defined by a range of a capture device (e.g., 222) (step 910). At 920, a gesture cursor control mode within the computing device can be triggered based on the detected gesture such that the user can manipulate a cursor within a display portion (e.g., 242) of the computing device through movement of selected portions of the hand of the user (e.g., a thumb and a finger tip) within the working volume of the computing device. In some embodiments, the detected gesture may be positioning the hand so that the palm faces inward and the thumb and index finger are in a horizontal plane. For the purposes of disclosed embodiments, a horizontal plane need not be exactly horizontal (i.e., 90 degrees from vertical). Instead, a plane may be considered horizontal if the plane has an angle ranging from of 80 to 110 degrees, where 90 degrees is exactly horizontal and 0 degrees is vertical. In some embodiments the location of a third portion of the hand (e.g., the thenar webbing) may also be located and used to determine whether the detected gesture triggers the gesture cursor control mode. In other words, the computing device may use three portions of the hand to determine whether the plane defined by the three points is horizontal. In other embodiments, the gesture may be the actuation of a special key (e.g., 244).

At 930, the computing device may identify a location of a first portion of the hand of the user (e.g., the tip of the thumb) along with a location of a second portion of the hand of the user (e.g., the tip of the index finger). As previously discussed, in some embodiments a pixel classification module may determine whether each pixel in a captured image is part of a hand, and if so, classify the pixel as a particular part of the hand. The pixel classification module may group the pixels and identify the location of each part of the hand as the center of the group of pixels that make up that part of the hand.

At 940, the computing device may determine whether the distance between the location of the first portion of the hand the location of the second portion of the hand falls below a threshold. If the distance is below the threshold (e.g., the tip of the thumb and the tip of the finger are touching) then the computing system may trigger a grasping event (step 944). A grasping event may be a selection event that selects an icon or control, similar to when a mouse button is pressed. The grasping event may last as long as the distance between the first and second portions stays below the threshold. The grasping event may initiate a click-and-drag movement of an icon or other control, such as a scroll bar control, that lasts until the grasping event ends.

If the distance between the first and second portions is above the threshold (step 940, No) then the computing system may end a grasping event, if one is currently ongoing (step 942). For example, the end of a grasping event may toggle an input, such as a checkbox or a radio button (similar to a click-and-release of a mouse button). The termination of a grasping event may also initiate actuation of a button or icon on the display portion, or may simply change the focus of the user interface to an item displayed on the display portion.

At 950, the computing system may position a cursor within the display portion (e.g., 242) based on a focus point identified between the location of the first portion of the hand and the location of the second portion of the hand. For example, the computing system may identify a focus point that is one-third of the way between the location of the first portion of the hand (e.g., the tip of the thumb) and the location of the second portion of the hand (e.g., the tip of the index finger). In other embodiments the focus point may be half way between the two locations. The computing system may translate the location of the focus point to a corresponding location on the display portion (e.g., 242) and cause a cursor (e.g., 248) at the corresponding location.

If a grasping event is ongoing, the computing system may also cause a selected icon or other control to be positioned along with the cursor in the display portion of the computing device, similar to a click-and-drag event. In other embodiments, if the user moves his or her hands away from the display device the computing system may make the selected item larger (e.g., zoom into a selected document). In other embodiments, a backwards motion may result in moving the icon (and the cursor) towards the bottom of the display portion. Other manipulations of a selected icon or control of the display may be implemented based on an ongoing grasping event and the direction of hand movement within the working volume.

At 960, the computing system may determine whether text based control has been triggered. For example, if the computing device determines that the two portions (or three portions) of the hand are no longer in a generally horizontal plane, then the computing system may trigger text based control. In other embodiments, the computing system may receive the actuation of a special key (e.g., key 244), a voice command that initiates the text based control mode, or the user may select a text box in the user interface of the display portion. In yet other embodiments, the user may wave his or her hands or snap his or her fingers to trigger text based control. If text based control is not triggered (960, No), then the computing system may repeat steps 930 to 950, allowing the user to control he cursor based on hand movements. If text based control is triggered (960, Yes), process 900 ends.

Embodiments of the various techniques described herein may be implemented in digital electronic circuitry, or in computer hardware, firmware, software, or in combinations of them. Embodiments may implemented as a computer program product, i.e., a computer program tangibly embodied in an information carrier, such as a machine-readable storage device (computer-readable medium), for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A computer program product, the computer program product being tangibly embodied on a computer-readable storage medium and comprising instructions that, when executed by one or more processors, cause a computing device to:
detect a plurality of parts of a human hand within a working volume of the computing device;
determine that the plurality of parts are in a configuration suitable for a grasping gesture; and
translate a location of the plurality of parts to a visual representation on a display of the computing device,
the visual representation allowing a user to interact with the computing device.

2. The computer program product of claim 1, wherein as part of the detecting, the instructions are further configured to detect at least three portions of the hand and, as part of the determining, determine that the first portion of the hand, the second portion of the hand, and the third portion of the hand are in a configuration for the grasping gesture.

3. The computer program product of claim 1, the instructions further configured to:
make an initial determination that the plurality of parts of the hand are in a horizontal plane; and
in response, initiate a cursor control mode allowing the user to manipulate the cursor by moving the plurality of parts of the hand within the working volume.

4. The computer program product of claim 3, the instructions further configured to cause the computing device to:
receive an input based on a predetermined position of the plurality of parts of the hand, the input configured to trigger termination of the cursor control mode and trigger a keyboard control mode of the computing device.

5. The computer program product of claim 1, wherein the plurality of parts include a portion of a thumb and a portion of a finger.

6. The computer program product of claim 5, the instructions further configured to cause the computing device to initiate a select-and-hold input when a distance between the portion of the thumb and the portion of the finger meets a threshold.

7. The computer program product of claim 6, the instructions further configured to cause the computing device to:
select an object presented on the display in response to initiating the select-and-hold input, the object corresponding with the visual representation on the display.

8. The computer program product of claim 7, further comprising instructions configured to cause the computing device to:
detect a movement of the portion of the thumb and the portion of the finger in the working volume during the select-and-hold input; and
reposition the object on the display based on the detected movement.

9. The computer program product of claim 5, further comprising instructions configured to cause the computing device to:
identify a focus point located between the portion of the thumb and the portion of the finger, wherein the focus point corresponds to the location of the plurality of parts.

10. The computer program product of claim 9, wherein as part of the identifying, the instructions are further configured to cause the computing device to identify the focus point at a location closer to the portion of the thumb than the portion of the finger.

11. A computer-implemented method, comprising:
detecting, by one or more processors, a first location of a first portion of a hand and a second location of a second portion of the hand within a working volume of a computing device;
determining that the first portion of the hand and the second portion of the hand are in a horizontal plane; and
positioning a visual representation on a display of the computing device based on the first location and the second location, wherein the hand is not in contact with the display of the computing device.

12. The method of claim 11, further comprising initiating a cursor control mode in response to the determining, the cursor control mode allowing a user to manipulate the visual representation by moving the hand within the working volume.

13. The method of claim 12, further comprising:
determining that the location of the first portion and the location of the second portion are not in a horizontal plane; and
terminating the cursor control mode and triggering a keyboard control mode of the computing device.

14. The method of claim 11, wherein the determining further includes detecting a location of a third portion of the hand and determining that the location of the first portion, the location of the second portion, and the location of the third portion are in the horizontal plane.

15. The method of claim 11, further comprising identifying a focus point located between the first location and the second location, wherein the visual representation is positioned at the focus point.

16. The method of claim 15, further comprising initiating a selection input when a distance between the first portion and the second portion meets a predetermined threshold.

17. The method of claim 16, further comprising:
selecting an object presented on the display in response to initiating the selection input, based on a location of the focus point on the display.

18. The method of claim 17, further comprising:
detecting a movement of the first portion of the hand and the second portion of the hand in the working volume while the distance between the first portion and the second portion remains below the predetermined threshold; and
repositioning the object on the display based on the detected movement.

19. The method of claim 15, wherein the identifying includes identifying the focus point at a location closer to the location of the first portion of the hand than the location of the second portion of the hand.

20. A computing device including instructions recorded on a non-transitory computer-readable medium and executable by at least one processor, the computing device comprising:
a gesture classification module configured to detect a gesture of a user within a working volume associated with the computing device, the gesture classification module configured to trigger initiation of a gesture cursor control mode of operating the computing device when the gesture matches a predetermined gesture signature stored within the computing device;
an imaging device configured to provide imaging data associated with the working volume to the gesture classification module; and
a gesture tracking module configured to:
position a cursor within a display portion of the computing device at a location based on a position of a first portion of a hand and a position of a second portion of the hand within the working volume, and
move the cursor within the display portion to correspond to movement of the first portion of the hand and the second portion of the hand within the working volume when the computing device is in the gesture cursor control mode.

21. The computing device of claim 20, wherein as part positioning the cursor, the gesture tracking module is configured to:
determine a location of the first portion of the hand of the user and the second portion of the hand of the user within the working volume; and
locate a focus point between the location of the first portion and the location of the second portion.

22. The computing device of claim 21, wherein the first portion of the hand is a tip of a thumb and the second portion of the hand is a tip of a finger and the focus point is located closer to the location of the thumb than the location of the finger.

23. The computing device of claim 20, wherein the predetermined gesture signature includes the first portion of the hand and the second portion of the hand being in a horizontal plane within the working volume.

24. The computing device of claim 20, wherein the imaging device includes a capture device configured to provide 3-dimensional information associated with the working volume to the gesture tracking module.

25. The computing device of claim 20, wherein the imaging device is located within a housing of the computer computing device.

26. The computing device of claim 25, wherein the working volume is above a keyboard portion of the computing device.

27. The computing device of claim 20, wherein the gesture classification module is further configured to:
detect a second gesture of the user within the working volume; and
initiate a selection input when the second gesture matches a second predetermined gesture signature stored within the computing device.

28. The computing device of claim 27, wherein the second gesture signature includes a distance between the first portion of the hand and the second portion of the hand meeting a predetermined threshold.
